(19) United States
(12) Patent Application Publication
(10) Pub. No.: US 2007/0078842 A1
(43) Pub. Date: Apr. 5, 2007

(54) System and method for responding to a user reference query

(76) Inventors: Scot Gregory Zola, Edison, NJ (US); Eric J. Glover, North Brunswick, NJ (US); Rohit Mittal, Somerset, NJ (US); Apostolos Gerasoulis, Edison, NJ (US); Stephen Lee Orr, La Jolla, CA (US); Gary Chevsky, Alamo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/315,513

(22) Filed: Dec. 21, 2005

Related U.S. Application Data
(60) Provisional application No. 60/723,064, filed on Sep. 30, 2005.

(51) Int. Cl. G06F 17/30

(52) U.S. Cl. 707/4

(57) ABSTRACT

The invention provides a system and method for providing an output in response to a user reference query. A user reference query is received and an answer to the user reference query is determined. A unique entity identifier (EID) for the answer is determined and used to query a reference system to determine one or more reference elements, e.g. a reference summary, a picture, or a video, for example. The one or more reference elements and a text of the answer are provided to an output provider. The output provider combines the one or more reference elements and the answer text into a single output. In one exemplary configuration, the single output is a graphical user interface transmitted as an extensible markup language (XML) file, which integrates the answer text and the one or more reference elements.

### CROSS REFERENCE TO RELATED APPLICATIONS

This application is related to and claims the benefit of U.S. Patent Provisional Application No. 60/723,064, entitled “USE OF A QUESTION ANSWERING ENGINE TO AUTOMATICALLY SELECT RELEVANT REFERENCE CONTENT,” filed on Sep. 30, 2005, which is herein incorporated by reference in its entirety.

### BACKGROUND

1. Field of the Invention

This invention relates to computing devices and, in particular, to a system and method for providing an output in response to a user reference query.

2. Description of Related Art

Vast amounts of digital data exist today, all interconnected by a web of networks. The web of networks allows user and organizations to publish the digital data, e.g. as part of a personal web page or organization website. The web of networks also allows users and organizations to facilitate transactions between them, e.g. purchasing of product and services. The web of networks also allows a user to search for information about a topic of interest.

To search for information about a topic of interest, a user must search through the vast amounts of data to find a particular piece of information. To facilitate searching, prior art systems have implemented keyword search engines that allow a user to enter keywords to search.

However, even using keyword search engines, a search for information can be a time consuming task, especially when a user is not completely certain of what keywords to use to search for information on a concept that the user otherwise knows how to describe. For example, the user may want to search for information on the winner of the 1934 Triple Crown. However, the user may not realize that the winner of the 1934 Triple Crown is “Lou Gehrig,” and therefore may not realize that “Lou Gehrig” is the most direct keyword query to use to search for information on the concept of Lou Gehrig.

It may take some time before the user discovers that he/she should submit the keyword query “Lou Gehrig” to a keyword search engine to find information on Lou Gehrig. Furthermore, in some cases, after the user finds references containing information pertinent to Lou Gehrig, it takes additional steps for the user to review each reference individually and actually learn about Lou Gehrig, i.e. the actual concept of interest.

### SUMMARY

The invention provides a method for providing an output in response to a user reference query including receiving the user reference query; determining an answer to the user reference query; providing a text of the answer; extracting a unique entity identifier (EID) for the answer; querying a reference system using the EID to determine a reference element; and providing an output including the text of the answer and the reference element.

The user reference query may not contain any keywords also in the text of the answer.

The answer to the user reference query be determined by matching the user reference query, regardless of form or language, to at least one answer having a relationship to the user reference query determined by a relational database.

The answer may be determined by, when the user reference query contains an ambiguity, requesting clarification from a user.

Requesting clarification from the user may include providing a selectable list presenting at least two domains of content.

The selectable list may further presents an alternative answer to the user reference query for each of the at least two domains of content.

When the user reference query contains an ambiguity, providing the output may include a request for clarification from a user.

Providing the unique entity identifier (EID) for the answer may include identifying the EID in an automatically created inverted index of entities to references.

Querying the reference system using the EID may include at least one of: looking up content in a flat database based on the EID and executing a server call including the EID to an external data partner.

The method may further include applying a template modification rule to the output to output an extensible markup language (XML) file including the text of the answer and the reference summary.

The method may further comprise querying the reference system using the EID to determine at least one other reference element related to the answer.

The invention also provides a user interface presented to a user, the user interface including text of an answer to a user reference query determined in response to submission of the user reference query, said text prominently presented relative to a remainder of the user interface; and a reference element resulting from querying a reference system using a unique entity identifier (EID) for the answer.

The text of an answer may fail to contain any keyword also contained in the user reference query.

The reference element may be selected from the group consisting of: a reference summary, a picture, an audio file, a video file, a multi-media file, and a link to content directly associated with the EID.

The reference summary may be a paragraph of text about the answer. The paragraph may contain greater than 200 characters. The paragraph may contain between 200 and 300 characters, inclusively.

The reference summary may be selected from the group consisting of: an encyclopedia article summary, an almanac topic summary, a dictionary definition, a journal abstract, a book jacket description, and a summary of a bot-indexed web page.

The user interface may further include a second reference element resulting from said querying of the reference system using the EID, wherein the second element selected from the group consisting of: a picture, an audio file, a video file, a multi-media file, and a link to content directly associated with the EID.

The user interface may further include, when the user reference query includes an ambiguity, a selectable list presenting an additional domain of content. The selectable list may further present an alternative answer for the user reference query corresponding to the additional domain of content.

The invention further provides a system for providing an output in response to a user reference query including a receiver for receiving the user reference query; an answering engine, connected to the receiver, to determine an answer to the user reference query; a text provider, connected to the answering engine, to provide a text of the answer; an entity identifier (EID) provider, connected to the answering engine, to provide a unique EID for the answer; a reference query engine, connected to the EID provider, to query a reference system using the EID to determine a reference element; and an output provider, connected to the text provider and the reference query engine, to provide an output including the text of the answer and the reference element.

The answer to the user reference query may be variable over time.

The system may further include a network interface, connected to the reference query engine, through which the reference query engine retrieves from an external data partner the reference element.

The system may further include memory, connected to the EID provider, to store an automatically created inverted index of entities to references; and an automatic index generator, connected to the memory, to automatically create the inverted index of entities to references.

### BRIEF DESCRIPTION OF THE DRAWINGS

The invention is further described by way of example with reference to the accompanying drawings wherein:

FIG. 1 is a conceptual flow diagram of data in a system in accordance with one embodiment of this invention;

FIG. 2 is a block diagram of components on a client side and on a server side routing and/or processing data in accordance with the flow of FIG. 1;

FIG. 3 is a block diagram of a network scheme including the server side components of FIG. 2;

FIG. 4 is a block diagram of a process using the components of FIG. 3; and

FIGS. 5A through 5D are representations of a user interface displayed on a client system of FIG. 3.

### DETAILED DESCRIPTION OF THE INVENTION

The present invention provides a system and method for responding to a user reference query. When a user reference query is received, aspects of this invention determine an answer to the user reference query using an answering technology. Aspects of this invention then provide a unique identifier for each concept in the answer. Using the unique identifier(s), aspects of this invention determine one or more reference elements directly relevant to the unique identifier(s). The answer and the one or more reference elements are combined (or “fused”) into one output and provided in response to the user reference query.

Therefore, unlike conventional query systems, applications of the present invention provide an output which is based on an answer to a query, rather than on the query itself, therefore ensuring that the output is directly relevant to the answer. Additionally, applications of the present invention provide an output which is not simply a path to additional information directly relevant to the answer, but rather a substantive source of information directly relevant to the answer. Accordingly, conventional query systems may provide a link to an output of the present invention, or otherwise integrate the outputs of the present invention into its results.

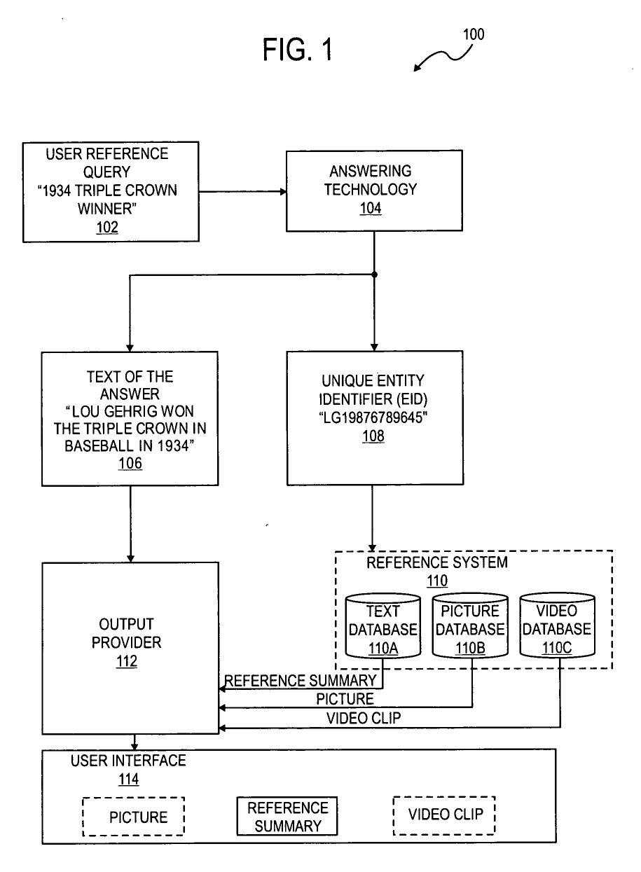

FIG. 1 illustrates a conceptual flow 100 of data in a system of the present invention. In FIG. 1, the flow involves a user reference query 102, an answering technology 104, a text of the answer 106 to the user reference query 102, an EID 108 for the answer to the user reference query 102, a reference system 110, an output provider 112, and a user interface 114. The reference system 110 includes various reference databases, such as a text database 110A (i.e. a database including reference text), a picture database 110B (i.e. a database including pictures), and a video database 110C (i.e. a database including video).

In FIG. 1, the conceptual data flow 100 begins with the user reference query 102. A user query to any system, such as database systems or search engine systems, can be understood to be based on the intent of the user. Accordingly, user queries may be divided into categories.

A first category of user queries is associated with queries involving web mediated tasks, e.g. buying an airline ticket or other e-commerce activities. User queries in the first category use a network, e.g. the Internet, to facilitate transactions between a user and another legal entity, e.g. a business.

A second category of user queries is associated with locating a site on the network, e.g. looking for the homepage of the 2006 Olympics. User queries in the second category are primarily concerned with navigating to sites within the network.

A third category of user queries is associated with searching for reference information. Queries in this category may be in the form of a question, such as “Who won the Triple Crown in 1934?”, or may not be in the form of a question, such as “1934 Triple Crown winner”. User queries in the third category are primarily concerned with determining an answer to the “question” (whether or not in question form) and with providing reference information relating to the answer. Accordingly, a user reference query involves searching for reference information including, but not limited to statistical data, for example. User queries in the third category are only collaterally associated with finding another site on the network.

Many times, a user reference query does not contain any keywords also contained in the text of an answer to the user reference query. For example, the user reference query “Who won the Triple Crown in 1934?” lacks any words (including keywords) also in the text of the answer “Lou Gehrig won the triple crown in baseball in 1934”.

Additionally, many times, the answer to the user reference query is variable over time. When an answer is “variable over time”, the answer is capable of changing over time, although such a change may, in actuality, take decades to occur, or may not occur at all. Consequently, the answer to the user reference query may differ depending on when the query is asked. For example, if the user reference query is “Who has the most home runs in American Major League Baseball?”, the answer can change over time as different players exceed the home run record, which may occur within weeks, within decades, or never at all. If the user reference query is “President of the United States”, the answer changes on a regular basis.

The user reference query 102 is provided to an answering technology 104. The answering technology 104 determines an answer to the user reference query, as described in further detail below. The answering technology 104 outputs a text of the answer 106 to the “question” and an EID 108.

In the illustrative embodiment described here, the text of the answer (or answer text) 106 is a string of characters understandable in a human language. In the present example, the text of the answer is “Lou Gehrig won the triple crown in baseball in 1934”.

The EID 108 is a string of characters, such as a string of alphanumeric characters for example, which can have no standard meaning in a human language and yet uniquely identifies a concept (also known as an “entity”) within the system of the present invention. In FIG. 1, the EID associated with “Lou Gehrig” is “LG19876789645”.

The concept identified by the EID may also be identified in a human language using a word which is simultaneously used to identify a separate concept, i.e. a word which is not unique to the concept. For example, in the English language, the word “Georgia” identifies both a state (in the United States) and a sovereign nation (previously part of the Soviet Union). In other words, the word “Georgia” simultaneously identifies to two separate concepts.

In the system of the present invention, each of the concepts above (Georgia, the state, and Georgia, the sovereign nation) is associated with a unique EID. For example, Georgia, the state, may be associated with an EID such as 17423128751 while Georgia, the nation, may be associated with the EID 892300918298. As seen in FIG. 1, the unique EID associated with “Lou Gehrig,” the 1934 triple crown winner, is “LG19876789645”.

In a system in which a domain of content causes the text of the answer to itself be unique to a concept, the text of the answer may also serve as the EID. A domain of content is a logical space relating to a certain category of entities, e.g. states, nations, or baseball. In exemplary applications of the present invention, the domain of content involves sports, sports statistics, demographics, and/or politics. For example, in one application of the present invention, a system implementing the invention may provide outputs in response to user reference queries that relate only to the United States. Accordingly, the text of the answer “Georgia” may itself serve as the EID because, in such a system, “Georgia” is string of characters that uniquely identifies the concept of Georgia, the state.

This unique EID is used by the system of the present invention to identify references containing information about the entity associated with the EID. The references and associated reference elements may be contained in the reference system 110, which, in this illustrative embodiment, includes various databases, such as, for example, the text database 110A (which includes textual reference data), the picture database 110B, the video database 110C, an audio file database, a multimedia file database, and a link database.

Each of the databases in the reference system may be any model of databases, including flat and relational. A flat database is a database which consists of a single, two-dimensional array of elements, where all the members of a given column have similar value types, and all members of a given row are related to one another. An example of a flat database is a security database having a table with a column for names and a column for passwords. A relational database is a database which contains multiple tables, each table similar to the one in the flat database model, wherein keys are used to match different rows in different tables.

In FIG. 1, the unique EID is used to identify references in one or more of the databases in the reference system 110. A reference element is then provided to the output provider 112. In FIG. 1, the reference element provided to the output provider 112 is a reference summary associated with a reference identified using the EID “LG19876789645”.

A reference summary is a textual summary of a reference identified using an EID. A reference summary provides more than just an indication that a reference found in the reference system is associated with the answer to a user reference query. Accordingly, in certain applications, the reference summary is a paragraph, e.g. a paragraph containing greater than approximately 200 characters, e.g. between approximately 200 and 300 characters, providing more substantive information about the answer. In certain configurations, a reference summary may include data (e.g. mark-up tags or metadata) not readily perceivable to an end-user, e.g. extensible markup language (XML) tags.

Generally, a reference element is data (e.g. textual data, audio data, or video data) provided to the output provider 112 that is associated with a reference. For example, a summary of an article in the text database 110A is a reference element associated with the article. A low resolution version of a high resolution photograph in the picture database 110C is a reference element associated with the photograph. A trailer for a video in the video database 110C is a reference element associated with the video. A clip of that same video is another reference element associated with that video. Other examples of reference elements include: an encyclopedia article summary, an almanac topic summary, a dictionary definition, a journal abstract, a book jacket description, and a summary of a bot-indexed web page. Some references may be considered themselves to be a reference element, e.g. a link in the link database or a low resolution picture in the picture database. Each of the databases in the reference system 110 includes references, references elements, or both. In certain applications, more than one reference element is provided to the output provider 112.

In FIG. 1, the output provider 112 receives both a reference summary and the text of the answer 106. In one exemplary configuration, the output provider uses (or “fuses”) the reference summary and the text of the answer 106, outputting a single user interface 114, e.g. a web page. In FIG. 1, the user interface 114 includes the answer text (e.g. “Lou Gehrig”), the reference summary (e.g. a paragraph about Lou Gehrig), and other reference elements received by the output provider (e.g. a picture of Lou Gehrig and a video clip relating to Lou Gehrig).

The single user interface 114 generated in certain embodiments of this invention may be retrieved by other user interface generators and embedded as an object in the other user interfaces. For example, in use of the present invention in a larger system, the single user interface 114 is retrieved by a search engine and presented as part of a web portal.

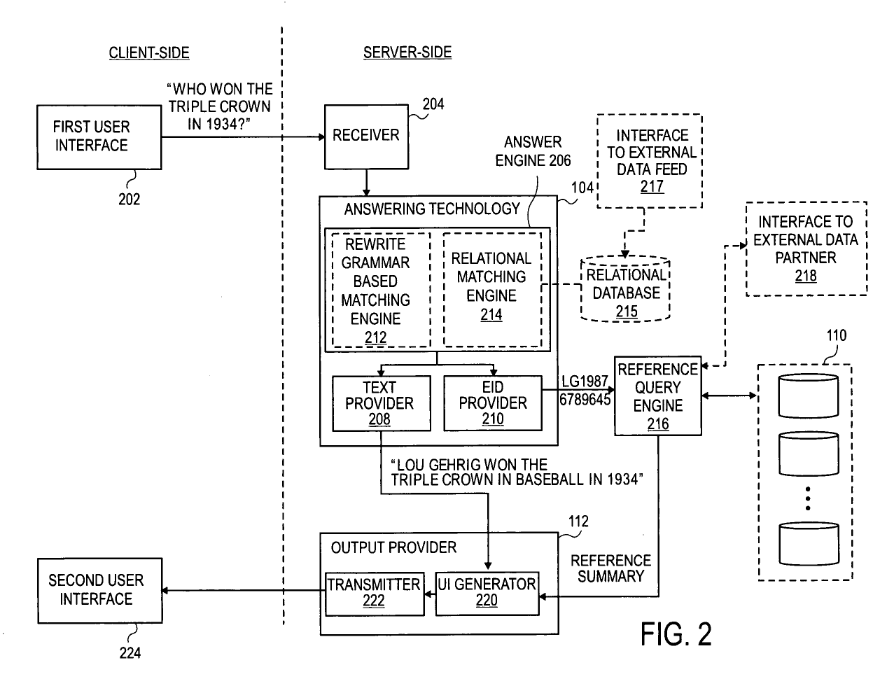

FIG. 2 illustrates client side and server side components which implement the data flow shown in FIG. 1. In FIG. 2, the client side includes a first user interface (UI) 202 and a second UI 224. The server side includes a receiver 204, an answering technology 104, a reference query engine 216, a reference system 110, an output provider 112, and an optional interface to an external data partner 218. The answering technology 104 includes an answer engine 206, a text provider 208, and an EID provider 210 connected to the reference query engine 216.

The answer engine 206 is a query processing engine which determines answers to user reference queries. In certain configurations, the answer engine 206 determines answers based on a database, e.g. by using executing SQL commands against the database. In the illustrative configuration shown in FIG. 2, the answer engine 206 is shown to include, optionally, a rewrite grammar based matching engine 212 and a relational matching engine 214 connected to an optional relational database 215. The relational database 215 is connected to an interface to an external data feed 217.

The output provider includes a graphical UI generator 220 connected to the reference query engine 216 and a transmitter 222.

In use, a user uses the first user interface 202, e.g. a web page in a browser window, to submit a user reference query to the server side. In FIG. 2, the user reference query is “Who won the Triple Crown in 1934?”

The receiver 204 receives the user reference query on the server side 204. The receiver 204 includes hardware and/or software and, in one exemplary application, includes a network interface card (NIC). The receiver 204 is connected to the answering technology 104 and routes the user reference query (e.g. “Who won the Triple Crown in 1934?”) to the answering technology 104.

In the answering technology 104, the user reference query is inputted to the answer engine 206 to determine an answer to the user reference query. In certain configurations, the answer engine is configured to output only answers which are associated with a particular domain of content, only answers which are proper nouns, or only answers which are deictic. A deictic answer is an answer which depends on deictic clues, sometimes referred to as deictic words or deictic expressions. Deictic clues are words or expressions which rely absolutely on context to provide meaning, e.g. “I” or “tomorrow”.

The answer engine 206 may be configured to provide these exclusive outputs by, for example, being connected to database(s) having only certain types of answers, or answers associated with a specific domain or content. The answer engine 206 may also be configured in to provide these exclusive outputs by, for example, accepting only those queries which require such exclusive output. For example, the answer engine 206 may be configured to accept only queries which contain a deictic expression, or which contain a comparative term (e.g. “most” or “least” or any term indicating a location on a scale). Because determining an answer to queries which contain a comparative term often includes analyzing statistical data, e.g. a number of homeruns in a season, the answering engine 206, in certain configurations, includes a statistical analysis engine. The answer engine may also include other specific types of engines. For example, in the illustrative configuration shown, the answer engine 206 includes both a rewrite grammar based matching engine 212 and a relational matching engine 214.

The rewrite grammar based matching engine 212 and the relational matching engine 214 determine answers to user reference queries based on two different concepts. The rewrite grammar based matching engine 212 determines answers to user reference queries based on a concept of rewrite grammars. A rewrite grammar is a set of replacement rules, each of which specifies that a given phrase may be replaced by another given phrase. A parser finds the sequences of replacements. Each sequence represents a meaning or interpretation for the given text. Therefore, although the rewrite grammar based matching engine 212 parses a query, the matching algorithm used by the rewrite grammar based matching engine 212 is indifferent as to the data structure involved in the parsing process, whether the data structure is tree based, chart based, stacked based, etc. The matching algorithm used by the rewrite grammar based matching engine 212 is also indifferent as to the type of parsing used, e.g. top down, bottom up, breadth first, or depth first.

The relational matching engine 214 determines answers to user reference queries based on matching user reference queries to specific answers that stand in relation to the user query as determined by a relational database, e.g. the relational database 215 connected to the relational matching engine 214. In FIG. 2, the relational database 215 is connected to an external data feed via the interface 217. Through the interface 217, one or more external data partners can provide and/or update data used by the answer engine 206 to determine answers to user reference queries. Accordingly, the relational matching engine 214 is able to identify a specific answer to the user relational query regardless of the form or language of the query. The technology used by the relational matching engine 214 is described in further detail in U.S. Patent Provisional Application No. 60/702,524, entitled “QUESTION TAGGING—FAST AND SCALABLE DEVELOPMENT OF QUESTION ANSWERING FOR STRUCTURED DATA—DATABASES AND XML FEEDS,” which was filed on Jul. 25, 2005, and is herein incorporated by reference in its entirety.

An answer engine within the scope of this invention may include none, one, or both of engines 212 and 214, as well as other engines (not shown). The answer engine 206 may then use each of these sub-engine(s) as appropriate based on a current user reference query, such as based on a structure, language (Romanized or non-Romanized), and/or data format (e.g. audio) of the user reference query. For example, in one application, the answer engine 206 may receive a user reference query consisting of a mathematical equation, solve the mathematical equation without using either of the engines 212 or 214, and provide the solution to the equation as the answer to the user reference query.

The answer determined by the answering engine 206 is provided to the text provider 208. In certain applications, the text provider 208 is configured to convert the answer into an appropriate human understandable form, e.g. from a machine-readable form to a human readable form, or from one human language to another, or from audio to text, or text to audio.

The answer determined by the answering engine 206 is also provided to the EID provider 210. The EID provider 210 extracts one or more EIDs for the answer, e.g. from an index 320 discussed below, and provides the EID(s) to the reference query engine 216. In FIG. 2, the EID provider 210 provides the EID “LG19876789645” to the reference query engine 216.

In the present example, a single EID (e.g. “LG19876789645”) is described as being associated with the answer to a user reference query. In other applications within the scope of the invention, the answer to a user reference query contains more than one entity, and therefore is associated with more than one EID. For example, if the user reference query is “Who played in the quarterback position for the San Francisco 49ers during the 2004-2005 season?”, the answer may contain multiple entities. In this case, the answer contains four entities: “Tim Rattay,” “Alex Smith,” “Ken Dorsey,” and “Cody Pickett.” Therefore, for the answer to the query “Who played in the quarterback position for the San Francisco 49ers during the 2004-2005 season?”, the EID provider 210 extracts four separate EIDs, one for “Tim Rattay,” one for “Alex Smith,” one for “Ken Dorsey,” and one for “Cody Pickett,” and provides each entity to the reference query engine 216.

The reference query engine 216 queries the reference system 110, connected to the engine 216, using the EID to determine one or more reference elements, such as a reference summary, a picture, a video clip, an audio clip, a multi-media file, and/or a link, for example.

In FIG. 2, the reference query engine 216 is also connected to an optional interface to an external data partner 218. The interface 218 allows the reference query engine 216 to query additional databases as appropriate, e.g. when the answer is related to a certain domain of content.

As an example, in one application, the reference query engine 216 uses the interface 218 to execute a server call to an external data partner (e.g. the Federal Bureau of Investigation) to query references stored in the external data partner's database(s), e.g. databases of suspected terrorists. The server call includes the EID for the suspected terrorist. In some applications, the external data partner uses the same EID, i.e. the EID is standardized. In other applications, the external data partner converts the EID into another identifier used by the data partner's internal database system(s).

As another example, in another application, the reference query engine 216 uses the interface 218 to execute a server call to an external data partner for references stored in a database that requires a subscription or contract prior to access, e.g. a database of trade journal articles, court filings, or public records.

Referring again to FIG. 2, the reference query engine 216 transmits a reference element, e.g. a reference summary, to the output provider 112. In one exemplary configuration, the output provider 112 uses the graphical UI generator 220 to generate a user interface, e.g. the user interface 114 previously described with respect to FIG. 1.

This user interface is then provided to the transmitter 222. The transmitter 222 includes hardware and/or software and, in one exemplary application, includes a network interface card (NIC). The transmitter 222 transmits the user interface generated by the generator 220 to the client side. This is shown in FIG. 2 as the second UI 224 in the client side.

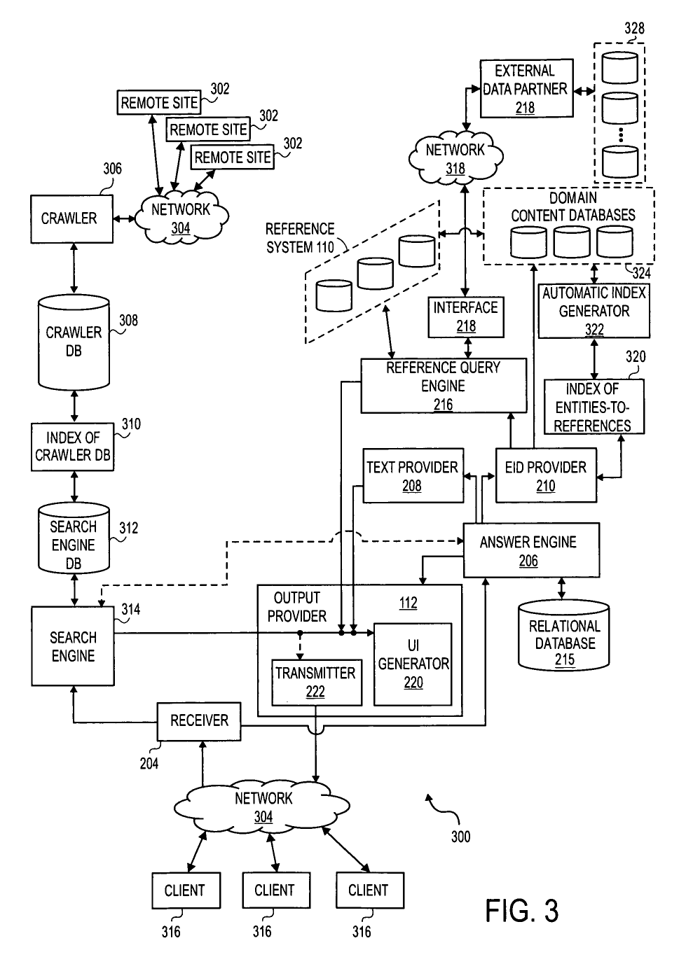

FIG. 3 illustrates a network scheme 300 which includes the system components of FIG. 2. In FIG. 3, the network scheme 300 includes remote sites 302, a network 304, a crawler 306, a crawler database 308, an index of the crawler database 310, a search engine database 312, a search engine 314, a receiver 204, clients 316, an answer engine 206, a relational database 215, a text provider 208, an EID provider 210, an index of entities-to-references 320, an automatic index generator 322, domain content databases 324, a reference system 110, a reference query engine 216, an interface to external data partners 218, a network 318, an external data partner 218, external data partner databases 328, and an output provider 112, which includes a UI generator 220 and a transmitter 222.

In use, the crawler 306, which may be a bot, for example, regularly and systematically searches the remote sites 302 via the network 304 (e.g. the Internet). The crawler 306 collects information relating to the remote sites 302, e.g. information included in metadata tags. The crawler 306 stores the collected information in the crawler database 308 connected to the crawler 306.

The crawler database 308 is also connected to the index of the crawler database 310. The index of the crawler database 310 is an index of the information stored in the crawler database 308. The index of crawler database 310 is connected to the search engine database 312.

The search engine database 312 includes mappings between keyword search terms and the information indexed in the index of crawler database 310. The search engine database 312 is connected to the search engine 314.

The search engine 314 uses the search engine database 312 to determine mappings between keywords received from a client 316 and the information stored in the crawler database 308.

When a client 316 connected to the network 304, submits keywords, such as “2006 Olympics” as part of a home page finding query, the keywords are received by the receiver 204 and transmitted to the search engine 314. The search engine 314 determines the relevant remote sites 302 associated with the keywords using the search engine database 312, the index 310, and the crawler database 308.

When the client 316 instead submits a user reference query, the user reference query is received by the receiver 204 and then transmitted to the answer engine 206 to determine an answer to the user reference query.

In one configuration, the receiver 204 determines whether to transmit the received query to the search engine 314 or to the answer engine 206 based on information in the header of the query. The header may indicate, for example, what user interface was used to submit the query.

In another configuration, the user reference query is transmitted from the client 316, to the receiver 204, and then to the search engine 314. The search engine 314 then determines whether the query is a user reference query or a different category of query. If the query is a user reference query, the search engine transmits the user reference query to the answer engine 206, shown in FIG. 3 by the dashed line connecting the search engine 314 and the answer engine 206. As previously discussed, the answer engine 206 may then use algorithms to determine an answer to the user reference query.

In certain applications, if the user reference query is ambiguous, the answer engine 206 communicates with the output provider 112 to output a user interface (e.g. a web page) requesting clarification from a user using the client 316. This communication is shown in FIG. 3 by the arrow directly connecting the answer engine 206 to the output provider 112.

For example, if the answer engine 206 receives the user reference query “Who won the Triple Crown in 1934?”, in one application, the answer engine 206 requests clarification from the client 316 because the answer engine 206 is unclear as to whether the domain of content is baseball, auto racing, or cricket, for example. After the ambiguity is clarified, the answer engine then applies the algorithm(s) to the user reference query to determine the answer to user reference query.

In certain applications, the answer engine 206 automatically determines the clarification based on parameters of its configuration. For example, if the answer engine 206 is implemented in a system dedicated to baseball, the answer engine will not need to request clarification from a user using the client 316. If the answer engine 206 is implemented in a system targeted towards users in the United States, as another example, the probability that a user reference query refers to cricket may be substantially low (i.e. below a threshold probability value) such that clarification from a user using the client 316 is unnecessary.

Referring again to FIG. 3, the answer engine 206 provides the answer to the EID provider 210, which determines one or more EIDs for the answer. In FIG. 3, the EID provider 210 is connected to the index of entities-to-references 320.

The index of entity-to-references 320 is a mapping between entities and references. Each entry in the index 320 maps an entity (as identified by an EID) to a reference. The index of entity-to-references 320 is automatically generated by the automatic index generator 322 as an inverted index.

The automatic index generator 322 is hardware and/or software connected to the domain content databases 324 and the reference system 110. The automatic index generator 322 uses the domain content databases 324 and the reference system 110 to create unique EIDs for concepts (or entities) which map between content in the reference system 110 and content in the domain content databases 324.

In use, the automatic index generator 322 analyzes a reference in the reference system 110, e.g. article. Based on terms in the article, the automatic index generator is able to determine that the article discusses content in a certain domain using the domain content database 324. For example, the automatic index generator is able to determine that a reference discussing “Georgia” is related to the state domain when the reference also includes the terms “United States” and “Atlanta,” terms listed in the domain content database 324 as being associated with the state domain. The automatic index generator 322 then automatically generates an entry in the index of entities-to-references 320 listing a unique EID for Georgia, the state, to the reference in the reference system 110 discussing Georgia the state.

When the automatic index generator 322 encounters a different article also including the term “Georgia,” but instead also including the terms “Soviet Union” and “Tbilisi”, terms listed in the domain content database 324 is being associated with the nation domain, the automatic index generator 322 determines the article is discussing a separate concept (or entity). The automatic index generator 322 then automatically generates a separate entry in the index of entities-to-references 320 mapping a different EID for Georgia, the nation, to the article in the reference system 110 discussing Georgia the nation. Therefore, using the domain content databases 324 and the reference system 110, the automatic index generator 322 automatically generates an inverted index of entity-to-references.

Referring again to FIG. 3, after the EID provider 210 determines an EID for the answer, the EID provider 210 provides the EID to the reference query engine 216. As discussed above, the reference query engine 216 determines a reference element, e.g. a reference summary, using the EID. The reference element is transmitted to the output provider 112 along with the answer text from the answer provider 208 as discussed above.

In one configuration, the reference summary and the answer text is transmitted directly back to the client using the transmitter 222 without a user interface being generated by the UI generator 220, e.g. in a reply string, file, or data signal. This is shown in FIG. 3 by the dashed line connecting the input from the reference query engine 216 and the input from the text provider 208 to the transmitter 222. The client 316 then uses the reference summary and the answer text in its own processes to generate its own UI.

In one configuration, the reference summary and the answer text is provided to the UI generator 220 to generate a graphical user interface combining the reference summary and the answer text. In one application, the UI generator 220 is configured to apply a template modification rule to the answer text and one or more reference elements, outputting an Extensible Markup Language (XML) file. For example, in one application, after the template modification rule is applied, the UI generator 220 outputs an XML file including the text of the answer, the reference summary, and/or another element such as a picture, an audio file, a video file, a multimedia file or a link to content associated with the EID, in a format customized for a certain client.

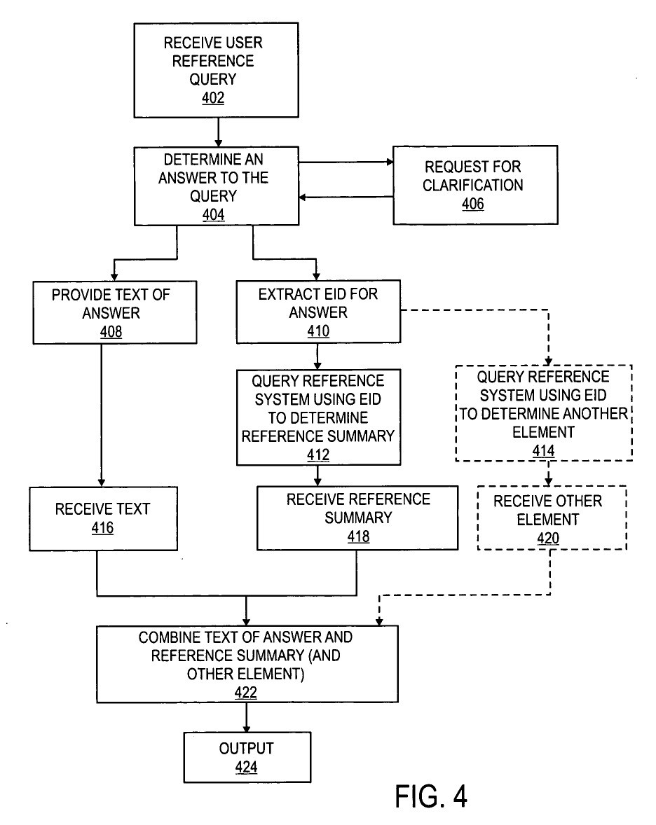

FIG. 4 illustrates a block flow diagram of a process of the present invention to provide further explanation. In FIG. 4, at 402, a user reference query is received from a client, e.g. by the receiver 204. At 404, an answer to the user reference query is determined. If clarification is required due to an ambiguity, the process continues to 406 where a request for clarification is issued to the client.

At 408, the text of the answer is provided, e.g. to the output provider 112, while, asynchronously, an EID for the answer is extracted at 410. At 412, the EID is used to determine a reference element (e.g. a reference summary) by querying the reference system. Asynchronously, the EID may be used to determine a different reference element (e.g. a picture) by querying the reference system (e.g. 110) and/or an external database system (e.g. 328).

At 416, 418, and 420, the text of the answer, the reference summary and, optionally, the other reference element, respectively, is received (e.g. by the output provider 112). At 422, the text of the answer, the reference summary and, optionally the other element are combined (or fused), e.g. into a graphical user interface using the UI generator 220, or into a reply string, file, email, or data signal (e.g. a data signal formatted for a mobile device). At 424, this user interface, reply string, file, email, or data signal is outputted.

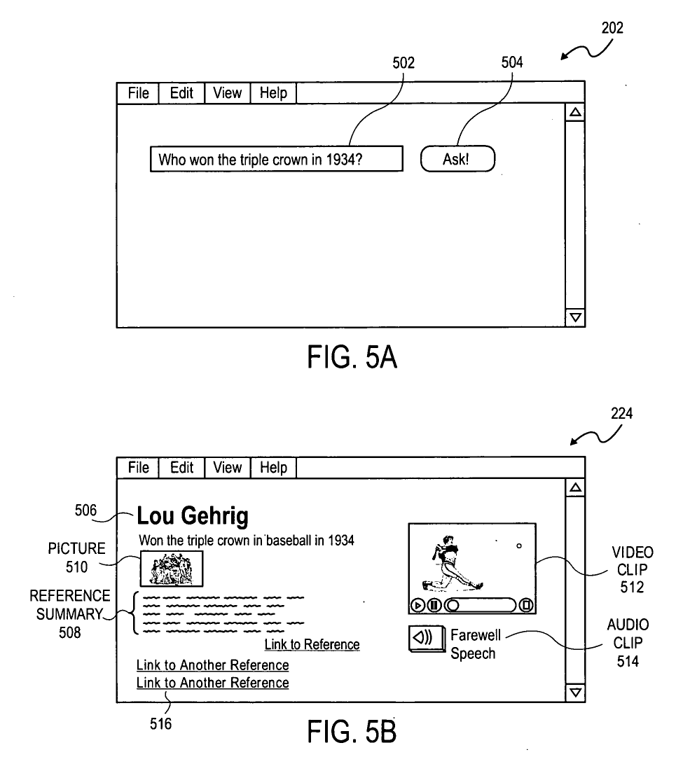

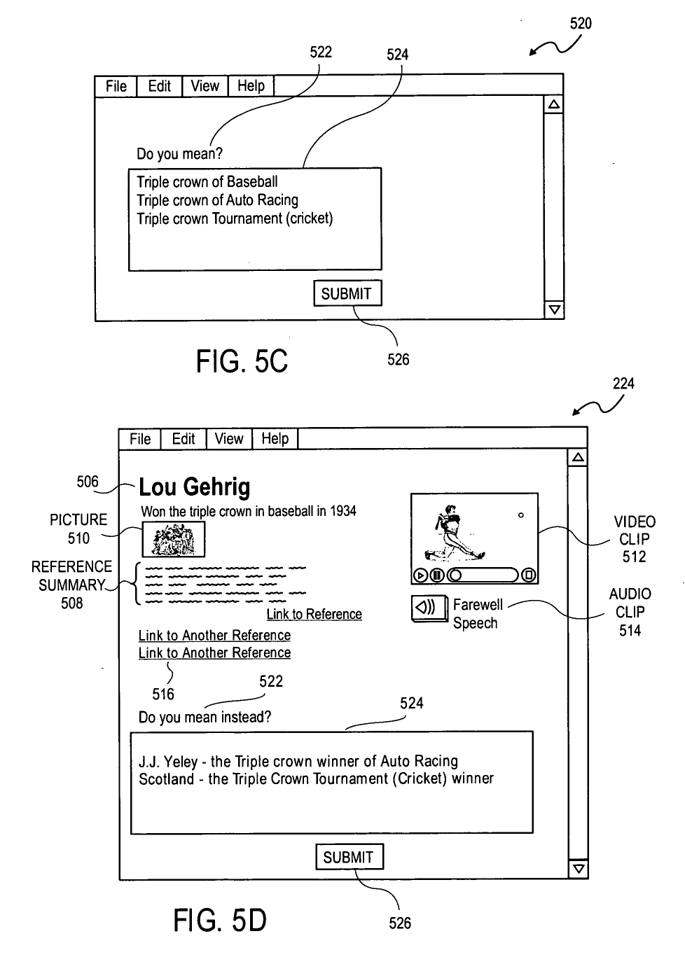

FIG. 5A illustrates a representation of the first user interface 202. The user interface 202 includes an input 502 and a submitter 504. The input 502 receives from an input device a user reference query, e.g. “Who won the Triple Crown in 1934?” or “1934 Triple Crown winner”. The input device may include, for example, a keypad, a microphone, a bot, etc. The submitter 504, when selected, submits the user reference query to the query system, i.e. the receiver 204, the answering technology 104, the reference query engine 216, and the output provider 112. In one application, the submitter 504 is a button selectable using a mouse and/or one or more keys.

FIG. 5B illustrates a representation of the second user interface 224. The second user interface 224 is presented in response to submission of the user reference query. The second user interface 224 includes a text 506 of the answer to the user reference query, a reference summary 508 resulting from querying a reference system using a unique EID for the answer, a picture 510, a video clip 512, an audio clip 514, and one or more links 516 to other references directly relevant to the concept represented by the unique EID. The picture video clip, audio clip, and links each results from querying the reference system using the unique EID for the answer.

In FIG. 5B, the text 506 of the answer (“Lou Gehrig won the triple crown in baseball in 1934”) is prominently presented relative to the remainder of the second user interface to allow the user to quickly understand the answer to the user reference query.

FIG. 5C illustrates a representation of a user interface used to clarify an ambiguity in the user reference query. The user interface 520 includes explanatory text 522 and a selectable list of elements 524 along with a submitter 526.

The explanatory text 522 explains to the user that the query system would like clarification of the user reference query to determine a domain of content.

The selectable list 524 provides a list of elements selectable by the user which details the available domains of content in relation to the user reference query. In FIG. 5C, this list includes “Triple Crown of Baseball”, “Triple Crown of Auto Racing” and “Triple Crown Tournament (cricket)”.

After the user selects from the list, the user submits the clarification to the query system using, for example, the submitter 526 or by pressing one or more keys. In one application, when the user selects from the list, the selection automatically submits the clarification to the query system without the user having to separately submit the clarification. In another words, the submission function is integrated into the selection function.

FIG. 5D illustrates another representation of the second user interface 224. Similar to FIG. 5B, the user interface 224 of FIG. 5D includes a prominently presented text 506 of the answer to the user reference query, and multiple reference elements directly relevant to the concept represented by the unique EID for the answer to the user reference query. In contrast to FIG. 5B, the user interface 224 of FIG. 5D includes a request for clarification of an ambiguity in the user reference query.

As in FIG. 5C, the selectable list 524 in FIG. 5D provides a list of elements selectable by the user which details other available domains of content relevant to the user reference query. In contrast to FIG. 5C, the selectable list 524 in FIG. 5D additionally identifies the answer to the user reference query corresponding to each of the other available domains. In one configuration, the selectable list 524 may identify answers to the user reference query from a single domain or from multiple domains, without explicitly identifying the domain(s). For example, the selectable list 524 may identify “J. J. Yeley” and “Scotland” without explicitly identifying “the Triple crown winner of Auto Racing” and “the Triple Crown Tournament (Cricket) winner,” respectively.

Thus, a system and method for responding to a user query is disclosed. In the description above, numerous specific details are set forth in order to provide a thorough understanding of the present invention. However, it will be apparent to one of ordinary skill in the art that these specific details need not be used to practice the present invention. In other circumstances, well-known structures, materials, or processes have not been shown or described in detail in order not to unnecessarily obscure the present invention.

For example, the use of the phrase “text of the answer” or the like throughout includes text that are understood through any one of the human senses, including the audio senses. Accordingly, when the answering technology 104 outputs a text of the answer 106 to the “question,” for example, the output may be in the form of visual text, audio text, tactile text, etc., such that people with varying disabilities may still benefit from the present invention.

Moreover, the use of the phrase “EID” or the like throughout includes strings of characters that are understood through any one of the human senses, including the audio senses. Accordingly, when the text of the answer is audio text, the text of the answer may to be unique to a concept, and therefore serve as the EID, when the pronunciation of the answer text is unique to the concept.

Moreover, the use of the phrase “a reference summary” or the like throughout includes a textual summary of a reference that can understood through at least one of the human senses, including the audio senses, such that people with varying disabilities may still benefit from the present invention. Accordingly, when the reference summary is a paragraph containing between approximately 200 and 300 characters, the reference summary may be an audio of a paragraph that correlates to between approximately 200 and 300 characters.

What is claimed:

1. A method for providing an output in response to a user reference query comprising:
receiving the user reference query;
determining an answer to the user reference query;
providing a text of the answer;
extracting a unique entity identifier (EID) for the answer;
querying a reference system using the EID to determine a reference element; and
providing an output including the text of the answer and the reference element.

2. The method of claim 1, wherein the user reference query does not contain any keywords also in the text of the answer.

3. The method of claim 1, wherein determining the answer to the user reference query includes matching the user reference query, regardless of form or language, to at least one answer having a relationship to the user reference query determined by a relational database.

4. The method of claim 1, wherein determining the answer includes, when the user reference query contains an ambiguity, requesting clarification from a user.

5. The method of claim 4, wherein requesting clarification from the user includes providing a selectable list presenting at least two domains of content.

6. The method of claim 5, wherein the selectable list further presents an alternative answer to the user reference query for each of the at least two domains of content.

7. The method of claim 1, wherein, when the user reference query contains an ambiguity, providing the output includes a request for clarification from a user.

8. The method of claim 1, wherein providing the unique entity identifier (EID) for the answer includes identifying the EID in an automatically created inverted index of entities to references.

9. The method of claim 1, wherein querying the reference system using the EID includes at least one of: looking up content in a flat database based on the EID and executing a server call including the EID to an external data partner.

10. The method of claim 1, further comprising applying a template modification rule to the output to output an extensible markup language (XML) file including the text of the answer and the reference summary.

11. The method of claim 1, further comprising querying the reference system using the EID to determine at least one other reference element related to the answer.

12. A user interface presented to a user, the user interface comprising:
text of an answer to a user reference query determined in response to submission of the user reference query, said text prominently presented relative to a remainder of the user interface; and
a reference element resulting from querying a reference system using a unique entity identifier (EID) for the answer.

13. The user interface of claim 12, wherein the text of an answer fails to contain any keyword also contained in the user reference query.

14. The user interface of claim 12, wherein the reference element is selected from the group consisting of: a reference summary, a picture, an audio file, a video file, a multi-media file, and a link to content directly associated with the EID.

15. The user interface of claim 14, wherein the reference summary is a paragraph of text about the answer.

16. The user interface of claim 15, wherein the paragraph contains greater than 200 characters.

17. The user interface of claim 15, wherein the paragraph contains between 200 and 300 characters, inclusively.

18. The user interface of claim 14, wherein the reference summary is selected from the group consisting of: an encyclopedia article summary, an almanac topic summary, a dictionary definition, a journal abstract, a book jacket description, and a summary of a bot-indexed web page.

19. The user interface of claim 12, further comprising a second reference element resulting from said querying of the reference system using the EID, wherein the second element selected from the group consisting of: a picture, an audio file, a video file, a multi-media file, and a link to content directly associated with the EID.

20. The user interface of claim 12, further comprising, when the user reference query includes an ambiguity, a selectable list presenting an additional domain of content.

21. The user interface of claim 20, wherein the selectable list further presents an alternative answer for the user reference query corresponding to the additional domain of content.

22. A user interface presented to a user, the user interface comprising:
a selectable list presenting answers to the user reference query, the answers outputted by an answer engine in response to receiving the user reference query; and
a reference element resulting from querying a reference system prior to selection by the user of an answer in the list, the querying using a unique entity identifier (EID) for one of the answers outputted by the answer engine.

23. The user interface of claim 22, wherein at least two of the answers are associated with different domains of contents.

24. The user interface of claim 22, wherein a single domain of content is associated with each of the answers outputted by the answer engine.

25. A system for providing an output in response to a user reference query comprising:
a receiver for receiving the user reference query;
an answering engine, connected to the receiver, to determine an answer to the user reference query;
a text provider, connected to the answering engine, to provide a text of the answer;
an entity identifier (EID) provider, connected to the answering engine, to provide a unique EID for the answer;
a reference query engine, connected to the EID provider, to query a reference system using the EID to determine a reference element; and
an output provider, connected to the text provider and the reference query engine, to provide an output including the text of the answer and the reference element.

26. The system of claim 25, wherein the answer to the user reference query is variable over time.

27. The system of claim 25, further comprising a network interface, connected to the reference query engine, through which the reference query engine retrieves from an external data partner the reference element.

28. The system of claim 25, further comprising:
memory, connected to the EID provider, to store an automatically created inverted index of entities to references; and
an automatic index generator, connected to the memory, to automatically create the inverted index of entities to references.

29. The system of claim 25, wherein the answering engine is further configured to output only answers which are associated with a particular domain of content.

30. The system of claim 29, wherein the particular domain of content involves at least one of sports, sports statistics, demographics, or politics.

31. The system of claim 25, wherein the answering engine is further configured to output only answers which are proper nouns.

32. The system of claim 25, wherein the answering engine is configured to accept only queries which contain a comparative term.

33. The system of claim 25, wherein the answering engine is configured to accept only queries which contain a deictic expression.
